(19) United States
(12) Patent Application Publication
(10) Pub. No.: US 2026/0009673 A1
(43) Pub. Date: Jan. 8, 2026

(54) METHOD OF DESIGN FOR SYNERGY BETWEEN HIGH-FREQUENCY DATA TRANSMISSION AND PRECISION-ADAPTIVE FAULT DIAGNOSIS

(71) Applicants: SHANGHAI JIAO TONG UNIVERSITY, Shanghai (CN); SHANGHAI ELECTRIC WIND POWER GROUP CO., LTD., Shanghai (CN)

(72) Inventors: Bo YANG, Shanghai (CN); Yu WU, Shanghai (CN); Dafeng ZHU, Shanghai (CN); Cailian CHEN, Shanghai (CN); Xinping GUAN, Shanghai (CN); Yong WANG, Shanghai (CN)

(21) Appl. No.: 19/220,787

(22) Filed: May 28, 2025

Related U.S. Application Data
(63) Continuation-in-part of application No. PCT/CN2024/139533, filed on Dec. 16, 2024.

(30) Foreign Application Priority Data
Jul. 4, 2024 (CN) 202410895486.3

(51) Int. Cl. G01H 17/00; G06N 3/0464; G06N 3/08

(52) U.S. Cl. CPC G01H 17/00; G06N 3/0464; G06N 3/08

(57) ABSTRACT

A method of design for synergy between high-frequency data transmission and precision-adaptive fault diagnosis, in which an edge gateway collects data, makes predictions for the data and transmits actual values whose deviations from predicted values exceed a threshold to a cloud server is disclosed. The cloud server recovers the data based on the actual values and predicted values of its own and outputs a fault diagnosis result based on the recovered data and a DPS length. The present application takes into account both data transmission and fault diagnosis accuracy and provides accurate real-time fault diagnosis with limited bandwidth resources.

### CROSS-REFERENCE TO RELATED APPLICATIONS

This application is a continuation-in-part (CIP) application claiming benefit of PCT/CN2024/139533 filed on Dec. 16, 2024, which claims priority to Chinese Patent Application No. 202410895486.3 filed on Jul. 4, 2024, the disclosures of which are incorporated herein in their entirety by reference.

### BACKGROUND

The present application relates to the field of online fault diagnosis, and particularly to a method of design for synergy between high-frequency data transmission and precision-adaptive fault diagnosis.

As demands for equipment safety and economy continue growing, online fault diagnosis has increasingly become indispensable to modern industry. In recent years, with the vigorous development of big data and artificial intelligence, fault diagnosis has shifted from an expert-oriented to data-driven technique. However, data-driven online fault diagnosis requires continuous, massive high-frequency data transmission. Since high-frequency data such as vibration signals are sampled at a frequency of at least 1 KHz, their real-time transmission would consume unaffordable bandwidth resources, leading to heavy network congestion and high network latency. Meanwhile, data quality has a direct impact on the accuracy of fault diagnosis. Therefore, how to effectively reduce real-time high-frequency data transmission while not compromising the accuracy of fault diagnosis represents the greatest challenge to fault diagnosis in practice.

In recent years, much effort has been invested in reducing online data transmission. However, most of the achievements are applicable to only simple data and cannot guarantee data availability. Dual prediction schemes (DPSs) can reduce real-time data transmission while guaranteeing a determined data accuracy range. Compared with DPSs based on traditional prediction models, those based on deep learning (DL) prediction models can cope with more complex data and provide high data prediction accuracy and more transmission reductions and are therefore becoming mainstream solutions.

Recently, many works have applied DL to the field of fault diagnosis and focused on solving practical problems in industrial scenarios. Yu et al. proposed a DL model based on transfer learning for diagnosing mechanical faults of unlabeled samples without known label space. Chai et al. proposed a multisource-refined transfer network for fault diagnosis problems with inconsistent domains and categories. Jiao et al. proposed source-free adaptation diagnosis for rotating machinery, which can continuously optimize and update a fault diagnosis model using unlabeled data. Shao et al. proposed a dual-threshold attention-guided generative adversarial network to provide a portable data generation solution for fault diagnosis with limited samples. All these methods are associated with a number of disadvantages because of not taking into account the impact of data transmission on online fault diagnosis.

In addition, in order to achieve good tradeoff between the volume of data transmission and the accuracy of fault diagnosis, application-oriented design for improved transmission efficiency has become a new direction of communication research. Currently, application-oriented design for improved transmission efficiency has become a new direction of communication research. Semantic-, task-and goal-oriented communications have attracted extensive attention from academia and industry. Feng et al. proposed a goal-oriented bandwidth allocation framework. By optimizing the information utility gain of transmission data for applications, it effectively improves the performance of typical applications in cyber-physical systems. Wang et al. proposed a semantic communication framework for textual data transmission. By extracting and transmitting semantic information modeled by knowledge graphs, it effectively reduces data transmission and ensures semantic similarity of textual data. Yang et al. proposed an edge-driven semantic extraction scheme to meet the computing, storage, and communication requirements of semantic communications using edge intelligence.

Chinese Pat. App. Pub. No. CN114640695A discloses a method for effective transmission of high-frequency time-series data based on long-sequence dual prediction and Informer in a smart factory. In this method, cloud-edge collaborative long-sequence dual prediction architecture is first set up, and a trained long-sequence prediction model is then deployed at an edge gateway and a cloud server in the architecture. Finally, a long-sequence dual prediction scheme (L-DPS) is used to reduce online high-frequency data transmission while ensuring data accuracy. Compared with those in traditional dual prediction methods, the long-sequence prediction model used in this method is improved in structure and requires a reduced number of inference cycles, greatly expanding the range of applicable frequencies. Therefore, it can be used to reduce high-frequency data transmission required in smart manufacturing. Additionally, Informer, the most recent deep learning model, is introduced to overcome the issues of gradient vanishing and model inference time surge that may arise from the use of long-sequence prediction, making the method able to further reduce data transmission and applicable to a wider range of frequencies.

The existing methods for online fault diagnosis are required to provide reliable real-time transmission of high-frequency signals such as vibration signals. How to provide accurate real-time fault diagnosis at a limited bandwidth represents an important and crucial challenge that the field of fault diagnosis is faced with in practice.

Therefore, effort in the art is being directed toward developing a method of design for synergy between high-frequency data transmission and precision-adaptive fault diagnosis.

### SUMMARY

In view of the above described shortcomings of the prior art, the problem sought to be solved by the present application is how to provide accurate real-time fault diagnosis at a limited bandwidth.

To this end, the present application provides a method of design for synergy between high-frequency data transmission and precision-adaptive fault diagnosis, which comprises the steps of:
S101: collecting high-frequency data, pre-processing the high-frequency data, writing the pre-processed high-frequency data into a dataset and transmitting it to a cloud server, by an edge gateway;
S102: receiving the dataset transmitted from the edge gateway and training an Informer long-sequence prediction model using the dataset, by the cloud server;
S103: loading the trained Informer long-sequence prediction model synchronously to the cloud server and the edge gateway;
S104: implementing a long-sequence dual prediction method to make predictions for the high-frequency data, calculating deviations of predicted values from actual values and transmitting actual values whose deviations exceed a threshold to the cloud server, by the edge gateway;
S105: implementing the long-sequence dual prediction method to make predictions for the high-frequency data and recovering the high-frequency data based on the received data, by the cloud server; and
S106: inputting the recovered high-frequency data and a DPS length associated with the high-frequency data to a precision-adaptive fault diagnosis model by the cloud server and outputting a fault diagnosis result online by the precision-adaptive fault diagnosis model.

Additionally, in the step S101, the pre-processing of the high-frequency data by the edge gateway may comprise time-series transformation and normalization.

Additionally, the time-series transformation may be accomplished by adding a timestamp online to each sampled value of the high-frequency data, which marks a collection time of the high-frequency data.

Additionally, the timestamp may comprise year, month, day, hour, minute, second and millisecond information and may be in the format of “yyyy-MM-dd HH:mm:ss.SSS”.

Additionally, the normalization may be accomplished by regularizing numeral values of the high-frequency data to numeral values between −1 and 1.

Additionally, the normalization may be accomplished using an arc-tangent function normalization method, in which the arc-tangent function normalization utilizes the following function for processing:

$${x}_{i} = \frac{2}{π} arctan ( x )$$

where xᵢ is a normalized value, and x is an original value.

Additionally, in the S102, after receiving the dataset transmitted from the edge gateway, the cloud server may divide the dataset into a training set, a validation set and a test set.

Additionally, in the S102, training the Informer long-sequence prediction model with the dataset by the cloud server may comprise the sub-steps of:
S1021: training the Informer long-sequence prediction model using the training set, by the cloud server;
S1022: adjusting hyper-parameters of the Informer long-sequence prediction model using the validation set, by the cloud server;
S1023: performing verification on the test set, obtaining an optimum prediction model, by the cloud server; and
S1024: saving the optimum model obtained from the training as a file, by the cloud server.

Additionally, in the S103, the cloud server may transmit the optimum prediction model for the Informer long-sequence prediction model to the edge gateway and load the optimum prediction model synchronously with the edge gateway.

Additionally, the S104 may comprise the sub-steps of:
S1041: collecting the high-frequency data and pre-processing the high-frequency data by the edge gateway, obtaining the actual values of the high-frequency data;
S1042: making predictions for the high-frequency data using the Informer long-sequence prediction model, obtaining first predicted values of the high-frequency data, by the edge gateway;
S1043: calculating deviations of the first predicted values from the actual values and determining whether the deviations exceed the threshold, by the edge gateway;
S1044: if the deviations exceed the threshold, transmitting the actual values of the high-frequency data by the edge gateway; and
S1045: recovering the high-frequency data using the actual values and the first predicted values by the edge gateway.

Additionally, the S105 may comprise the sub-steps of:
S1051: making predictions for the high-frequency data using the Informer long-sequence prediction model, obtaining second predicted values of the high-frequency data, by the cloud server;
S1052: receiving the actual values of the high-frequency data transmitted from the edge gateway by the cloud server; and
S1053: recovering the high-frequency data using the actual values and the second predicted values by the cloud server.

Additionally, in the S106, the precision-adaptive fault diagnosis model may be based on one of the following architectures: a one-dimensional convolutional neural network, Transformer, a recurrent neural network and a multilayer perceptron.

Additionally, the precision-adaptive fault diagnosis model may be based on the one-dimensional convolutional neural network architecture, which comprises a block stack, a global average pooling layer and a fully connected layer and is configured to be able to accomplish extraction of local and global features of a vibration signal.

Additionally, the block stack may consist of a plurality of stacked blocks each comprising two convolutional layers and one maximum pooling layer.

Additionally, the two convolutional layers may be used to extract the local features of the vibration signals and each defined as:

$${X}_{i + 1}^{t} = C o n v 1 d ( {X}_{i}^{t} ) = R e L U ( {W}_{l} * {X}_{i}^{t} + {b}_{i} ) , where {X}_{i}^{t} and {X}_{i + 1}^{t}$$

are tensors, Wᵢ is a convolutional filter, bᵢ is a first bias term, ReLU(.) is a first activation function, i and i+1 are index numbers of layers, t is a time step, and Conv1d represents the convolutional layer.

Additionally, the maximum pooling layer may be used to extract higher-layer features of the vibration signal and defined as:

$${X}_{i + 1}^{t} = Max Pool ( {X}_{i}^{t} ) = max ( {X}_{i}^{t} ) ,$$

where MaxPool represents the maximum pooling layer, max takes a maximum, i and i+1 are index numbers of layers, t is a time step, and

$${{X}_{i}}^{t} and {X}_{i + 1}^{t}$$

are tensors.

Additionally, the global average pooling layer may be used to receive the higher-layer features output from the block stack and extract the global features of the vibration signal and defined as:

$${X}_{i + 1}^{t} = GlobalAvgPool ( {X}_{i}^{t} ) = \frac{1}{n} {\sum }_{j = 1}^{n} {X}_{i}^{t} ( j ) ,$$

where GlobalAvgPool represents the global average pooling layer, j is an index number, n is an input data length of the model, i and i+1 are index numbers of layers, t is a time

$${X}_{i}^{t} and {X}_{i + 1}^{t}$$

step, and are tensors.

Additionally, the fully connected layer may be used to receive the global features output from the global average pooling layer, configured to be able to output a fault label and defined as:

$${X}_{i + 1}^{t} = F C ( {X}_{i}^{t} ) = Soft max ( {W}_{l} {X}_{i}^{t} + {b}_{i} ) ,$$

where FC represents the fully connected layer, Wᵢ is a weight matrix, bᵢ is a second bias term, Softmax(.) is a second activation function, i and i+1 are index numbers of layers, t is a time step, and

$${X}_{i}^{t} and {X}_{i + 1}^{t}$$

are tensors.

Additionally, the S106 may comprise the sub-steps of:
S1061: inputting the recovered high-frequency data and the DPS length associated with the high-frequency data to the precision-adaptive fault diagnosis model by the cloud server;
S1062: extracting the local features and the higher-layer features of the vibration signal by the block stack;
S1063: extracting the global features of the vibration signal based on the higher-layer features by the global average pooling layer; and
S1064: obtaining the fault label of the vibration signal based on the global features and outputting the fault diagnosis result by the fully connected layer.

Additionally, the DPS length associated with the high-frequency data may be configured based on a frequency of the high-frequency data.

Compared with the prior art, the present application offers the benefits as follows.
1. The present application provides a design with synergic collaboration between an algorithm for real-time compressed transmission of high-frequency data and online fault diagnosis applications that it supports, which enables good tradeoff between data transmission reductions and fault diagnosis accuracy. In this way, in addition to real-time compressed transmission of high-frequency data at a limited bandwidth, accurate data transmission and fault diagnosis can be ensured. Thus, accurate real-time fault diagnosis can be achieved with limited bandwidth resources.
2. In the present application, prior information about a DPS length is taken as a precision reference for transmitted and recovered data, and the proposed model can adapt itself to transmitted and recovered data with different precisions, providing improved fault diagnosis accuracy.
3. In the present application, nonlinear arc-tangent function normalization is utilized to equilibrate relative differences between numeral values of a high-frequency vibration signal, thereby allowing samples with relatively small numeral values to also be effectively trained. In this way, time-series prediction accuracy of the algorithm for real-time compressed transmission of high-frequency data is effectively increased.

For a full understanding of the objects, features and effects of the present application, the concept, structural details and resulting technical effects will be further described with reference to the accompanying drawings.

### BRIEF DESCRIPTION OF THE DRAWINGS

FIG. 1 is a flowchart of a method of design for synergy according to an embodiment of the present application.

FIG. 2 is a schematic diagram showing an architecture with synergy between data transmission and fault diagnosis designed in accordance with an embodiment of the present application.

FIG. 3 is a schematic diagram showing a precision-adaptive fault diagnosis model according to an embodiment of the present application.

FIG. 4 is a schematic diagram showing data recovery accuracy at a DPS length of 10 according to an embodiment of the present application.

FIG. 5 is a schematic diagram showing data recovery accuracy at a DPS length of 50 according to an embodiment of the present application.

### DETAILED DESCRIPTION

A few preferred embodiments of the present application are described below with reference to the drawings accompanying this specification so that the techniques disclosed herein become more apparent and better understood. The present application may be embodied in many different forms, and its scope sought to be protected hereby is not limited only to the embodiments disclosed herein.

Throughout the accompanying drawings, structurally identical parts are indicated with the identical reference numerals, and structurally or functionally similar components are indicated with similar reference numerals. In the drawings, the size and thickness of each component are arbitrarily depicted, and the present application is not limited to the size or thickness of any component. For greater clarity of illustration, the thicknesses of some parts may be exaggerated somewhere in the drawings.

The existing methods for online fault diagnosis are required to provide reliable real-time transmission of high-frequency signals such as vibration signals. However, due to limited bandwidth resources, it is difficult to satisfy both the high-frequency and real-time requirements. In order to achieve good tradeoff between the volume of data transmission and the accuracy of fault diagnosis, Chinese Pat. App. Pub. No. CN114640695A discloses a method for effective transmission of high-frequency time-series data based on a long-sequence dual prediction scheme (L-DPS) and Informer in a smart factory. In this method, a cloud-edge collaborative long-sequence dual prediction architecture is first set up, and a trained long-sequence prediction model is then deployed at edge gateways and a cloud server in the architecture. Finally, the long-sequence dual prediction scheme (L-DPS) is used to reduce online high-frequency data transmission while ensuring data accuracy. Compared with those in traditional dual prediction methods, the long-sequence prediction model used in this method is improved in structure and requires a reduced number of inference cycles, greatly expanding the range of applicable frequencies. Therefore, it can be used to reduce high-frequency data transmission required in smart manufacturing. Additionally, Informer, the most recent deep learning model, is introduced to overcome the issues of gradient vanishing and model inference time surge that may arise from the use of long-sequence prediction, making the method able to further reduce data transmission and applicable to a wider range of frequencies.

In view of failure of the existing methods for online fault diagnosis to achieve good tradeoff between the volume of high-frequency data transmission and the accuracy of fault diagnosis with limited bandwidth resources, the present application proposes a method of design for synergy between high-frequency data transmission and precision-adaptive fault diagnosis. In this method of design, an online fault diagnosis application collaborates with a high-frequency data transmission algorithm to provide accurate real-time fault diagnosis with limited bandwidth resources.

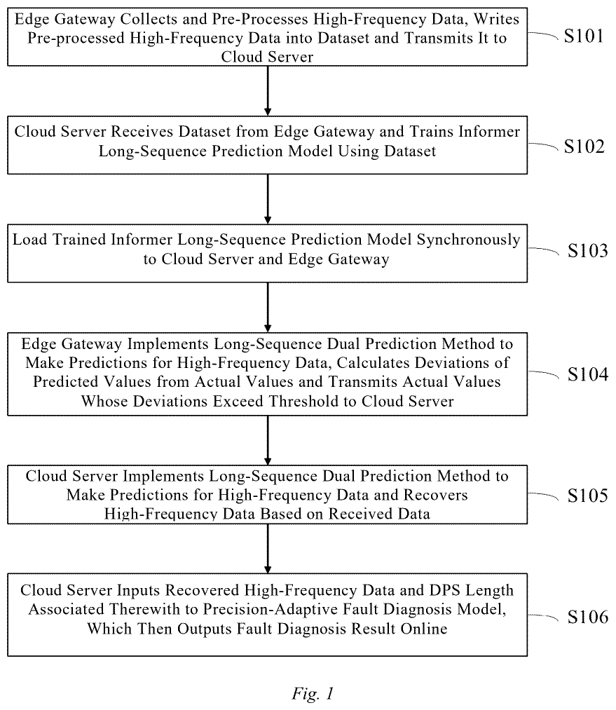

As shown in FIG. 1, a method of design for synergy between high-frequency data transmission and precision-adaptive fault diagnosis according to an embodiment of the present application includes the steps as follows.
Step 1: An edge gateway collects and pre-processes high-frequency data, writes the pre-processed high-frequency data into a dataset and transmits it to a cloud server.

Online fault diagnosis requires transmission of high-frequency signals, such as vibration signals. Such real-world analog signals are converted by sensors into electrical levels within a specified range, which are then additionally converted into digital signals by high-speed analog-to-digital conversion (high-speed) modules. Such digital signals are transmitted to the edge gateway through corresponding interfaces connected to the edge gateway, such as parallel interfaces, and high-speed cables. The gateway obtains raw data by decoding the signals using a corresponding driver and transmission protocol, and then carries out online pre-processing on the raw data. The pre-processing may include time-series transformation and arc-tangent function normalization, as described in detailed below.
1. Time-series transformation: This adds a timestamp to each sampled value online, which marks the collection time thereof. The timestamps are in the format of “yyyy-MM-dd HH:mm:ss.SSS”, i.e., “Year-Month-Day-Hour-Minute-Second-Millisecond”.
2. Arc-tangent function normalization: The sampled values vary greatly, and samples with small values tend to fail to be effectively trained, affecting the accuracy of time series prediction. Conventional normalization methods cannot reduce relative differences between the data values. Therefore, we adopt nonlinear arc-tangent function normalization to equilibrate the relative differences between the data values to enable samples with small values to be also effectively trained. Arc-tangent function normalization can regularize the values between −1 and 1, thereby effectively reducing the relative differences between them.

Arc-tangent function normalization is accomplished using the following function:

$${x}_{i} = \frac{2}{π} arctan ( x )$$

where xᵢ represents a normalized value, and x denotes the original value.

After completing the collection and pre-processing of the high-frequency data, the edge gateway writes the pre-processed high-frequency data into a dataset file. When the dataset file is considered to be sufficiently populated, the edge gateway transmits the dataset to the cloud server.
Step 2: The cloud server receives the dataset from the edge gateway and trains an Informer long-sequence prediction model with the dataset.

After receiving the dataset, the cloud server divides it up into a training set, a validation set and a test set. The training set is used to train the Informer long-sequence prediction model, and the validation set is then used to adjust hyper-parameters of the model. Finally, verification is carried out on the test set, and an optimum prediction model is thereby obtained and saved as a *.pkl file.

The Informer long-sequence prediction model serves to provide accurate, fast long-sequence time-series predictions in a long-sequence dual prediction scheme (L-DPS). Historical time-series data is input to the Informer long-sequence prediction model, which then performs prediction inference based thereon and outputs predicted values for future time-series data.

The training of the Informer long-sequence prediction model by the cloud server includes the sub-steps as follows:
Step 2.1: The cloud server trains the Informer long-sequence prediction model using the training set.
Step 2.2: The cloud server adjusts hyper-parameters of the Informer long-sequence prediction model using the validation set.
Step 2.3: The cloud server performs verification on the test set and thereby obtains an optimum prediction model.
Step 2.4: The cloud server saves the optimum model obtained from the training as a file.
Step 3: The trained Informer long-sequence prediction model is loaded synchronously to the cloud server and the edge gateway.

The cloud server transmits the file of the optimum prediction model to the edge gateway so that the optimum prediction model is loaded synchronously to it and the edge gateway. In this way, predictions can be made for high-frequency data.
Step 4: The edge gateway carries out a long-sequence dual prediction process to make predictions for high-frequency data, calculates deviations of the predicted values from actual values, and transmits actual values whose deviations exceed a threshold to the cloud server.

Before the edge gateway and the cloud server utilize the long-sequence dual prediction scheme (L-DPS) to make predictions for high-frequency data, a DPS length parameter is configured in advance for the L-DPS. This parameter affects the transmission reduction and data recovery accuracy requirements. The DPS length parameter is manually configured. The DPS length parameter may be determined by taking into account a frequency of high-frequency data. The DPS length parameter may be configured as a specific numerical value, such as 10 or 50. Different DPS lengths mean different precisions of recovered data. Generally, a smaller DPS length results in higher data recovery accuracy. After both the edge gateway and the cloud server successfully load the prediction model, the edge gateway collects and pre-processes raw data in real time, obtaining initial values. It then transmits n initial values to the cloud server, depending on an input length of the prediction mode. These values are taken as an initial input for the model. After that, the edge gateway can use the L-DPS to compress and transmit initial values obtained from the collection and pre-processing to the cloud server in real time.

In an L-DPS algorithm for real-time compressed transmission of high-frequency data, an L-DPS compression algorithm includes three mechanisms: dual prediction, confirmation and recovery. The dual prediction mechanism utilizes the Informer long-sequence prediction model to make predictions, and the edge gateway organizes and reports data based on the predictions. The confirmation mechanism screens and determines those of the actual values whose deviations from the predicted values exceed a threshold. If the predictions are so inaccurate that each of them made for data points of sampled values is associated with a deviation exceeding the threshold, all the actual values, i.e., the sampled values in the high-frequency data, are transmitted, and the L-DPS does not compress anything. If the predictions are so accurate that each of them made for the data points of the sampled values is associated with a deviation less than the threshold, none of the sampled values are reported, and the L-DPS achieves the highest compression efficiency. For more details of the L-DPS algorithm, reference is made to the disclosure of CN114640695A. Herein, no optimization is done to the L-DPS algorithm.

This step includes the sub-step as follows.
Step 4.1: The edge gateway collects and pre-processes high-frequency data, obtaining sampled values thereof.

The edge gateway pre-processes the high-frequency data in the same way as in step 1, and this essentially involves time-series transformation and arc-tangent function normalization. Through pre-processing the initial high-frequency data, sampled values thereof are obtained.
Step 4.2: The edge gateway uses the Informer long-sequence prediction model to make predictions for the high-frequency data, obtaining first predicted values thereof.
Step 4.3: The edge gateway calculates deviations of the first predicted values from the sampled values and determines whether the deviations exceed a threshold.
Step 4.4: If the deviations exceed the threshold, the edge gateway transmits the actual values of the high-frequency data.
Step 4.5: The edge gateway recovers the high-frequency data from the actual values and the predicted values.

The predicted values obtained from the predictions made by the edge gateway for the high-frequency data may deviate from the sampled value. If such deviations do not exceed the threshold, the edge gateway does not transmit the actually sampled values. Otherwise, the edge gateway transmits the actually sampled values, and the cloud server recovers the high-frequency data based on the actually sampled values.
Step 5: The cloud server carries out a long-sequence dual prediction process to make predictions for the high-frequency data and recovers the high-frequency data based on the received data.

Since the Informer long-sequence prediction model is loaded to both the cloud server and the edge gateway, the predictions made by the cloud server for the high-frequency data should be substantially consistent with those of the edge gateway. Therefore, the cloud server may utilize the L-DPS to receive the data from the edge gateway and recover the compressed data. As the edge gateway does not report the actual values if its predictions are consistent with the actually sampled values, in this case, the cloud server may recover the data directly from its own predicted values.

This step includes the sub-step as follows.
Step 5.1: The cloud server utilizes the Informer long-sequence prediction model to make predictions for the high-frequency data, obtaining second predicted values of the high-frequency data.
Step 5.2: The cloud server receives the actual values of the high-frequency data from the edge gateway.
Step 5.3: The cloud server recovers the high-frequency data from the actual values and the second predicted values.
Step 6: The cloud server inputs the recovered high-frequency data and the associated DPS length to a precision-adaptive fault diagnosis model, which then outputs a fault diagnosis result online.

The precision-adaptive fault diagnosis model is based on a one-dimensional convolutional neural network architecture including a block stack, a global average pooling layer and a fully connected layer. It is able to accomplish extraction of local features and global features of a vibration signal. The block stack consists of a plurality of stacked blocks, each including two convolutional layers and one maximum pooling layer.

This step includes the sub-step as follows.
Step 6.1: The cloud server inputs the recovered high-frequency data and the associated DPS length to a precision-adaptive fault diagnosis model.
Step 6.2: The block stack extracts local features and higher-layer features of a vibration signal.
Step 6.3: The global average pooling layer extracts global features of the vibration signal based on the higher-layer features.
Step 6.4: The fully connected layer obtains a fault label for the vibration signal based on the global features and outputs a fault diagnosis result.

The synergic algorithm for real-time compressed transmission of high-frequency data provided herein, as well as online fault diagnosis applications supported by data transmitted and recovered therefrom, can provide both significant transmission reductions and high fault diagnosis accuracy. Also provided is an architecture with synergy between transmission and diagnosis designed in accordance with the present application, which enables good tradeoff between data transmission reductions and fault diagnosis accuracy, thereby providing accurate real-time fault diagnosis with limited bandwidth resources. In view of different precisions of transmitted and recovered data, a precision-adaptive fault diagnosis model is also proposed, which can use a DPS length, which is prior information in the L-DPS algorithm for real-time compressed transmission of high-frequency data, as a precision reference to adapt itself to transmitted and recovered data with various precisions, thereby providing effectively improved fault diagnosis accuracy. In order to overcome the problem that an L-DPS time-series prediction model cannot be effectively trained due to dramatic variations in sampled values of a high-frequency vibration signal, it is proposed to carry out non-linear normalization pre-processing on the data using an arc-tangent function. Relative differences between high-frequency vibration signal values can be equilibrated by nonlinear arc-tangent function normalization, enabling samples with relatively small values to also be effectively trained. This effectively enhances the accuracy of L-DPS time-series prediction and additionally reduces the volume of transmission. The present application overcomes important and crucial challenges that challenge accurate real-time fault diagnosis with limited bandwidth resources in practice. Therefore, it is of utility, progressive and effective.

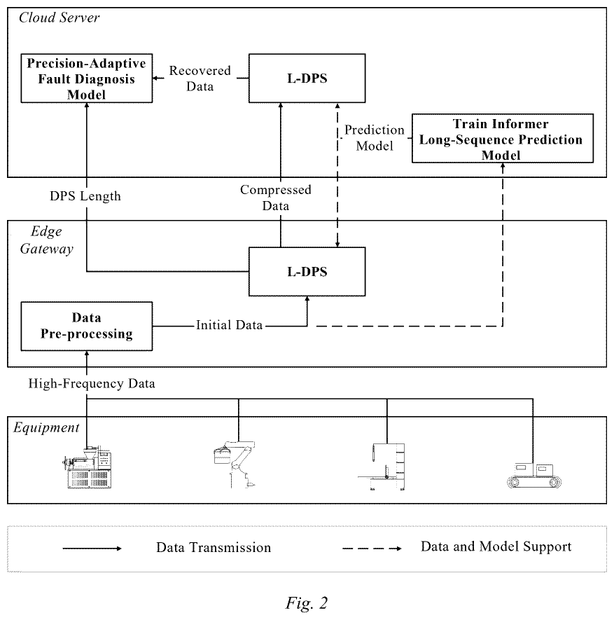

FIG. 2 shows an architecture with synergy between data transmission and fault diagnosis designed in accordance with an embodiment of the present application. This architecture provides synergic collaboration between a data transmission algorithm and a fault diagnosis application and achieves good tradeoff between the volume of high-frequency data transmission and the accuracy of online fault diagnosis. In terms of hardware, a cloud-edge collaborative approach is adopted, in which a prediction model is effectively trained on a cloud server using cloud resources, and the trained model is synchronously loaded to an edge gateway, which collects and pre-processes high-frequency data from equipment in real time and uses the prediction model to make predictions. The transmission algorithm is bridged to the fault diagnosis application by a DPS length, which serves as a precision reference for enabling a precision-adaptive fault diagnosis model to adapt itself to various precisions of data recovery, resulting in significantly improved fault diagnosis accuracy. The synergy between transmission and diagnosis enables the architecture to achieve both significant transmission reductions and high fault diagnosis accuracy.

In this embodiment, the edge gateway is responsible for collecting high-frequency data from equipment and pre-processing of the collected high-frequency data. The pre-processing involves time-series transformation and arc-tangent function normalization. The pre-processed data is transmitted to the cloud server in the form of a dataset for training an Informer long-sequence prediction model. The cloud server is responsible for training the Informer long-sequence prediction model using the test dataset from the edge gateway. After the training of the Informer long-sequence prediction model is completed, the cloud server transmits the trained Informer long-sequence prediction model to the edge gateway. In this way, both the cloud server and the edge gateway are loaded with the trained Informer long-sequence prediction model and therefore can make predictions for high-frequency data.

Both the cloud server and the edge gateway can run an L-DPS algorithm for real-time compressed transmission of high-frequency data to individually make predictions for high-frequency data and carry out data recovery based on such predictions.

High-frequency data recovered by the cloud server is input thereby along with an associated DPS length to the precision-adaptive fault diagnosis model, which then outputs a fault diagnosis result online.

The existing methods for online fault diagnosis are required to provide reliable real-time transmission of high-frequency signals such as vibration signals. When there are limited available bandwidth resources, it would be difficult to satisfy both the high-frequency and real-time requirements. However, alleviating the bandwidth burden by reducing data transmission would introduce a variation in the precision of transmitted data, which may degrade the accuracy of fault diagnosis. The proposed architecture with synergy between data transmission and fault diagnosis designed in accordance with the present application can provide both significant transmission reductions and high fault diagnosis accuracy by means of synergic collaboration between the L-DPS algorithm for real-time compressed transmission of high-frequency data and online fault diagnosis applications that it supports. The synergic design of the algorithm for real-time compressed transmission of high-frequency data and online fault diagnosis applications supported thereby enables good tradeoff between data transmission reductions and fault diagnosis accuracy. At a limited bandwidth, not only real-time compressed transmission of high-frequency data can be achieved, the precision of transmitted data and accurate fault diagnosis can be also ensured.

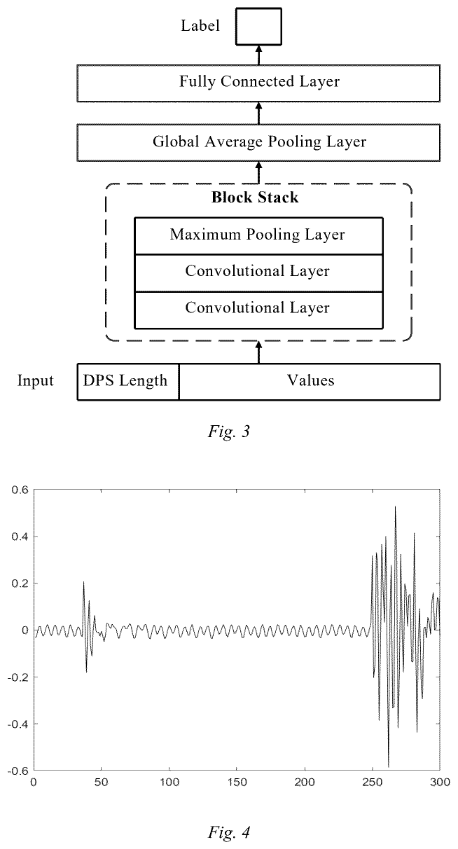

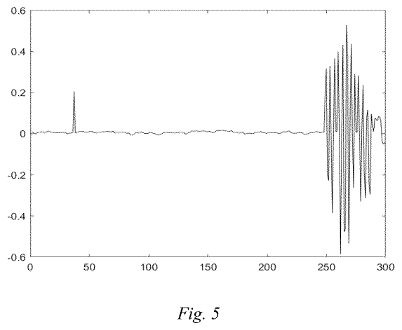

FIG. 3 shows a precision-adaptive fault diagnosis model according to an embodiment of the present application, which overcomes the problem of different precisions of transmitted and recovered data that may arise from the use of L-DPSs. This model is based on a one-dimensional convolutional neural network (CNN) architecture, which differs from traditional CNNs by additionally taking into account precision differences of transmitted data input to the model. Data transmission and diagnosis are bridged by a DPS length in an L-DPS, which provides a powerful precision reference for data input to the model. This model can adapt itself to various data recovery precisions, thereby providing both data transmission reductions and effectively improved fault diagnosis accuracy. This precision-adaptive fault diagnosis model includes convolutional layers, maximum pooling layers, a global average pooling layer and a fully connected layer. This model includes a block stack as its crucial component, which consists of a plurality of stacked blocks, each including two convolutional layers and one maximum pooling layer. This model mines prior information about the precision of a vibration signal contained in the DPS length. In addition to identifying a precision status of input vibration values, it can extract local and global features of the vibration signal. The DPS length is a user-defined parameter in the L-DPS algorithm, which has an impact on the precision of the vibration signal recovered by the L-DPS algorithm itself. The precision-adaptive fault diagnosis model can train, mine and learn the relationship of the DPS length and the precision of L-DPS recovered data, and exploits, during inference, the prior information about the data recovery precision obtained from the DPS length to provide more accurate fault diagnosis. The model effectively reduces the dimensionality of data and noise therein and enhances signal representation. Meanwhile, it can learn complex fault patterns through multi-layer nonlinear transformation, thus improving the accuracy and robustness of diagnosis. As can be seen in FIGS. 4 and 5, data recovered at different DPS lengths exhibits different precisions, as demonstrated by the different curves. As shown in FIG. 4, the data recovered at a DPS length of 10 has a higher precision. In contrast, the curve of FIG. 5, which is obtained at a DPS length of 50, is relatively flat and inaccurate, because many features have been smoothed away. The precision adaptivity provided herein is just because of, and motivated by, the fact that data recovered at different DPS lengths may show significant differences in precision.

In this embodiment, the precision-adaptive fault diagnosis model is based on a one-dimensional convolutional neural network architecture, which includes a block stack, a global average pooling layer and a fully connected layer and can accomplish extraction of local and global features of a vibration signal.

The block stack consists of a plurality of stacked blocks, each including two convolutional layers and one maximum pooling layer. The convolutional layers are used to extract local features of the vibration signal and each defined as:

$${X}_{i + 1}^{t} = Conv 1 d ( {X}_{i}^{t} ) = ReLU ( {W}_{i} * {X}_{i}^{t} + {b}_{i} ) ,$$

$$where {X}_{i}^{t} and {X}_{i + 1}^{t}$$

are tensors, Wᵢ is a convolutional filter, bᵢ is a first bias term, ReLU(.) is a first activation function, i and i+1 are index numbers of layers, t is a time step, and Conv1d represents the convolutional layer.

The maximum pooling layer is used to extract higher-layer features of the vibration signal and defined as:

$${X}_{i + 1}^{t} = MaxPool ( {X}_{i}^{t} ) = max ( {X}_{i}^{t} ) ,$$

where MaxPool represents the maximum pooling layer, max takes a maximum, i and i+1 are index numbers of layers, t is a time step, and

$${X}_{i}^{t} and {X}_{i + 1}^{t}$$

are tensors.

The global average pooling layer receives the higher-layer features from the block stack and extracts global features of the vibration signal. The global average pooling layer is defined as:

$${X}_{i + 1}^{t} = GlobalAvgPool ( {X}_{i}^{t} ) = \frac{1}{n} {\sum }_{j = 1}^{n} {X}_{i}^{t} ( j )$$

where GlobalAvgPool represents the global average pooling layer, j is an index number, n is an input data length of the model, i and i+1 are index numbers of layers, t is a time step, and

$${X}_{i}^{t} and {X}_{i + 1}^{t}$$

are tensors.

The fully connected layer receives the global features from the global average pooling layer and outputs a fault label. The fully connected layer is defined as:

$${X}_{i + 1}^{t} = FC ( {X}_{i}^{t} ) = Softmax ( {W}_{i} {X}_{i}^{t} + {b}_{i} )$$

where FC represents the fully connected layer, Wᵢ is a weight matrix, bᵢ is a second bias term, Softmax(.) is a second activation function, i and i+1 are index numbers of layers, t is a time step, and

$${X}_{i}^{t} and {X}_{i + 1}^{t}$$

are tensors.

In another embodiment of the present application, considering that the core idea of the precision-adaptive fault diagnosis model is that both recovered data and an associated DPS length is input to allow the model to adapt itself to the precision of the recovered data by mining a precision reference from the DPS length, although the CNN architecture is the most effective fault diagnosis architecture among those currently available, the precision-adaptive fault diagnosis model is not limited to be implemented as the CNN architecture. Instead, it may also be based on another architecture such as Transformer, a recurrent neural network (RNN), a multilayer perceptron, etc.

The precision-adaptive fault diagnosis model provided herein can work well with the transmission algorithm to provide accurate fault diagnosis for transmitted and recovered data with different precisions.

Compared with the prior art, the method of design for synergy between high-frequency data transmission and precision-adaptive fault diagnosis provided herein offers the benefits as follows.
1. The existing methods for online fault diagnosis are required to provide reliable real-time transmission of high-frequency signals such as vibration signals. When there are limited available bandwidth resources, it would be difficult to satisfy both the high-frequency and real-time requirements. However, alleviating the bandwidth burden by reducing data transmission would introduce a variation in the precision of transmitted data, which may degrade the accuracy of fault diagnosis. An architecture with synergy between data transmission and fault diagnosis is designed in accordance with the present application, which can provide both significant transmission reductions and high fault diagnosis accuracy by means of synergic collaboration between an L-DPS algorithm for real-time compressed transmission of high-frequency data and online fault diagnosis applications that it supports. The synergic design of the algorithm for real-time compressed transmission of high-frequency data and online fault diagnosis applications supported thereby enables good tradeoff between data transmission reductions and fault diagnosis accuracy. At a limited bandwidth, not only real-time compressed transmission of high-frequency data can be achieved, the precision of transmitted data and accurate fault diagnosis can be also ensured.
2. The existing fault diagnosis models fail to take into account different precisions of input data and therefore cannot adapt themselves to precision variations to data between compressed transmission and recovery. The resulting precision losses may make them unable to provide accurate fault diagnosis. In order to tackle precision differences between transmitted and recovered data, a precision-adaptive fault diagnosis model is proposed herein, in which prior information about a DPS length is taken as a precision reference for transmitted and recovered data. The proposed model can adapt itself to transmitted and recovered data with different precisions, thus effectively improving the accuracy of fault diagnosis.
3. Currently, data pre-processing is commonly accomplished by linear normalization, which cannot reduce relative differences of data value. Consequently, for sampled values of a high-frequency vibration signal that vary greatly, samples with small values tend to fail to be effectively trained, making accurate time-series prediction impossible. In order to overcome the problem that a time-series prediction model cannot be effectively trained with greatly varying sampled values of high-frequency vibration signals, it is proposed herein to pre-process such data by non-linear normalization using an arc-tangent function. Such nonlinear arc-tangent function normalization can equilibrate relative differences between high-frequency vibration signal values, enabling samples with relatively small values to also be effectively trained. This effectively enhances the accuracy of time-series prediction of an algorithm for real-time compressed transmission of high-frequency data.

Although a few preferred specific embodiments of the present application have been described in detail above, it will understood that those of ordinary skill in the art can make various modifications and changes thereto based on the concept of the present application without exerting any creative effort. Accordingly, all variant embodiments that can be obtained by those skilled in the art through logical analysis, inference or limited experimentation in accordance with the concept of the present invention on the basis of the prior art are intended to fall within the scope as defined by the appended claims.

1. A method of design for synergy between high-frequency data transmission and precision-adaptive fault diagnosis, the method comprising the steps of:
S101: collecting high-frequency data, pre-processing the high-frequency data, writing the pre-processed high-frequency data into a dataset and transmitting it to a cloud server, by an edge gateway;
S102: receiving the dataset transmitted from the edge gateway and training an Informer long-sequence prediction model using the dataset, by the cloud server;
S103: loading the trained Informer long-sequence prediction model synchronously to the cloud server and the edge gateway;
S104: implementing a long-sequence dual prediction method to make predictions for the high-frequency data, calculating deviations of predicted values from actual values and transmitting actual values whose deviations exceed a threshold to the cloud server, by the edge gateway;
S105: implementing the long-sequence dual prediction method to make predictions for the high-frequency data and recovering the high-frequency data based on the received data, by the cloud server; and
S106: inputting the recovered high-frequency data and a DPS length associated with the high-frequency data to a precision-adaptive fault diagnosis model by the cloud server and outputting a fault diagnosis result online by the precision-adaptive fault diagnosis model.

2. The method of claim 1, wherein in the S101, the pre-processing of the high-frequency data by the edge gateway comprises time-series transformation and normalization.

3. The method of claim 2, wherein the time-series transformation is accomplished by adding a timestamp online to each sampled value of the high-frequency data, which marks a collection time of the high-frequency data.

4. The method of claim 3, wherein the timestamp comprises year, month, day, hour, minute, second and millisecond information and is in the format of “yyyy-MM-dd HH:mm:ss.SSS”.

5. The method of claim 4, wherein the normalization is accomplished by regularizing numeral values of the high-frequency data to numeral values between −1 and 1.

6. The method of claim 5, wherein the normalization is accomplished using an arc-tangent function normalization method, in which the arc-tangent function normalization utilizes the following function for processing:
$${x}_{i} = \frac{2}{π} arctan ( x )$$
where xᵢ is a normalized value, and x is an original value.

7. The method of claim 6, wherein in the S102, after receiving the dataset transmitted from the edge gateway, the cloud server divides the dataset into a training set, a validation set and a test set.

8. The method of claim 7, wherein in the S102, training the Informer long-sequence prediction model with the dataset by the cloud server comprises the sub-steps of:
S1021: training the Informer long-sequence prediction model using the training set, by the cloud server;
S1022: adjusting hyper-parameters of the Informer long-sequence prediction model using the validation set, by the cloud server;
S1023: performing verification on the test set, obtaining an optimum prediction model, by the cloud server; and
S1024: saving the optimum model obtained from the training as a file, by the cloud server.

9. The method of claim 8, wherein in the S103, the cloud server transmits the optimum prediction model for the Informer long-sequence prediction model to the edge gateway and loads the optimum prediction model synchronously with the edge gateway.

10. The method of claim 9, wherein the S104 comprises the sub-steps of:
S1041: collecting the high-frequency data and pre-processing the high-frequency data, obtaining the actual values of the high-frequency data, by the edge gateway;
S1042: making predictions for the high-frequency data using the Informer long-sequence prediction model, obtaining first predicted values of the high-frequency data, by the edge gateway;
S1043: calculating deviations of the first predicted values from the actual values and determining whether the deviations exceed the threshold, by the edge gateway;
S1044: if the deviations exceed the threshold, transmitting the actual values of the high-frequency data by the edge gateway; and
S1045: recovering the high-frequency data using the actual values and the first predicted values by the edge gateway.

11. The method of claim 10, wherein the S105 comprises the sub-steps of:
S1051: making predictions for the high-frequency data using the Informer long-sequence prediction model, obtaining second predicted values of the high-frequency data, by the cloud server;
S1052: receiving the actual values of the high-frequency data transmitted from the edge gateway by the cloud server; and
S1053: recovering the high-frequency data using the actual values and the second predicted values by the cloud server.

12. The method of claim 11, wherein in the S106, the precision-adaptive fault diagnosis model is based on one of the following architectures: a one-dimensional convolutional neural network, Transformer, a recurrent neural network and a multilayer perceptron.

13. The method of claim 12, wherein the precision-adaptive fault diagnosis model is based on the one-dimensional convolutional neural network architecture, which comprises a block stack, a global average pooling layer and a fully connected layer and is configured to be able to accomplish extraction of local and global features of a vibration signal.

14. The method of claim 13, wherein the block stack consists of a plurality of stacked blocks each comprising two convolutional layers and one maximum pooling layer.

15. The method of claim 14, wherein the two convolutional layers are used to extract the local features of the vibration signals and each defined as:
$${X}_{i + 1}^{t} = Conv 1 d ( {X}_{i}^{t} ) = ReLU ( {W}_{i} * {X}_{i}^{t} + {b}_{i} ) ,$$
$$where {X}_{i}^{t} and {X}_{i + 1}^{t}$$
are tensors, Wᵢ is a convolutional filter, bᵢ is a first bias term, ReLU(.) is a first activation function, i and i+1 are index numbers of layers, t is a time step, and Conv1d represents the convolutional layer.

16. The method of claim 15, wherein the maximum pooling layer is used to extract higher-layer features of the vibration signal and defined as:
$${X}_{i + 1}^{t} = MaxPool ( {X}_{i}^{t} ) = max ( {X}_{i}^{t} ) ,$$
where MaxPool represents the maximum pooling layer, max takes a maximum, i and i+1 are index numbers of layers, t is a time step, and
$${X}_{i}^{t} and {X}_{i + 1}^{t}$$
are tensors.

17. The method of claim 16, wherein the global average pooling layer is used to receive the higher-layer features output from the block stack and extract the global features of the vibration signal and defined as:
$${X}_{i + 1}^{t} = GlobalAvgPool ( {X}_{i}^{t} ) = \frac{1}{n} {\sum }_{j = 1}^{n} {X}_{i}^{t} ( j ) ,$$
where GlobalAvgPool represents the global average pooling layer, j is an index number, n is an input data length of the model, i and i+1 are index numbers of layers, t is a time step, and
$${X}_{i}^{t} and {X}_{i + 1}^{t}$$
are tensors.

18. The method of claim 17, wherein the fully connected layer is used to receive the global features output from the global average pooling layer, configured to be able to output a fault label and defined as:
$${X}_{i + 1}^{t} = FC ( {X}_{i}^{t} ) = Softmax ( {W}_{i} {X}_{i}^{t} + {b}_{i} ) ,$$
where FC represents the fully connected layer, Wᵢ is a weight matrix, bᵢ is a second bias term, Softmax(.) is a second activation function, i and i+1 are index numbers of layers, t is a time step, and
$${X}_{i}^{t} and {X}_{i + 1}^{t}$$
are tensors.

19. The method of claim 18, wherein the S106 comprises the sub-steps of:
S1061: inputting the recovered high-frequency data and the DPS length associated with the high-frequency data to the precision-adaptive fault diagnosis model by the cloud server;
S1062: extracting the local features and the higher-layer features of the vibration signal by the block stack;
S1063: extracting the global features of the vibration signal based on the higher-layer features by the global average pooling layer; and
S1064: obtaining the fault label of the vibration signal based on the global features and outputting the fault diagnosis result by the fully connected layer.

20. The method of claim 19, wherein the DPS length associated with the high-frequency data is configured based on a frequency of the high-frequency data.
